(19) United States
(12) Patent Application Publication
(10) Pub. No.: US 2013/0346767 A1
(43) Pub. Date: Dec. 26, 2013

(54) Electronic Device

(71) Applicants: Kuei-Pi Cheng, New Taipei City (TW); Xufeng Wang, Shanghai City (CN)

(72) Inventors: Kuei-Pi Cheng, New Taipei City (TW); Xufeng Wang, Shanghai City (CN)

(21) Appl. No.: 13/532,965

(22) Filed: Jun. 26, 2012

(51) Int. Cl. G06F 1/26; H04W 8/00

(52) U.S. Cl. 713/310

(57) ABSTRACT

An electronic device is disclosed. The electronic device is applied in integrated-service environment, and users can have integrated services of Internet connection, portable power supply, and portable storage without carrying individual network device, portable power supply, and portable storage device. In other words, the electronic device of the present invention provides services/functions of Internet connection, portable power supply, and portable storage.

### BACKGROUND OF THE INVENTION

1. Field of the Invention

The present invention generally relates to a device, and more particular, relates to an electronic device applied in integrated-service environment, and users having integrated services of Internet connection, portable power supply, and portable storage.

2. The Prior Arts

Generally, a user would choose a specific portable electronic device having particular function(s) according to his/her needs. For example, while a user has a demand of portable power supply, he/she must carry a portable power supply device, while a user has a demand of network sharing, he/she must carry a IP sharing device, and, while a user has a demand of portable storage, he/she must carry portable storage device, such as, portable hard drive or usb pen driver.

In other words, at the present time, as regards those electronic devices, a user can not find an electronic device which can provide integrated services of Internet connection, portable power supply, and portable storage. And the user must carry several different electronic devices to satisfy his/her demands according to individual different function(s) of individual devices. However, it is inconvenient for the user.

Therefore, there is a need to solve an issue that an electronic device is provided to users, and users can have integrated services of Internet connection, portable power supply, and portable storage without carrying individual different corresponding electronic devices to satisfy his/her demands.

### SUMMARY OF THE INVENTION

Accordingly, it is a primary objective of the present invention to disclose an electronic device providing integrated services of Internet connection, portable power supply, and portable storage.

The above and other objectives of the present invention are achieved by an electronic device including a network connection module, a power supply module, and a portable storage module.

The network connection module comprises signal circuit, and network connection interface. The signal circuit has WiFi communication function, and the network connection interface is provided for electrically connecting to wired network, wherein, for example, the network connection interface is RJ-45 interface, the network connection module is connected to the Internet, the signal circuit converts signals from the RJ-45 interface into wireless WiFi signals and transmits/receives the wireless WiFi signals. Besides, the USB disk and/or the hand-held electronic devices (for example, mobile phone, iPad) and/or PC (Personal Computer) and/or laptop computer transmit(s) data to the Internet through the RJ-45 interface. Meanwhile, for example, the network connection interface is USB interface which accepts USB disk, and bi-directionally transmits data with the USB disk to proceed with data read/write procedure through the USB interface and/or the signal circuit proceeding WiFi communication.

The power supply module is charged by an external power source which is an AC (Alternating Current) power source with 110 voltage or 240 voltage through an input interface of the power supply module. And after the charging procedure, the power supply modules provide electric power to the network connection module and the portable storage module without electrically connecting with the AC power source.

While the AC power source is turn-on and input through the input interface, the power supply module converts the input AC power into a DC (Direct Current) power to charge a battery, and at least one LED element is used to indicate remaining electric power of the battery. The power supply module can also charge hand-held electronic devices (for example, mobile phone, iPad) connected with the network connection interface (USB interface) through the network connection interface (USB interface) of the network connection module.

Meanwhile, the input interface is optional, and, in other words, the power supply module can use the network connection interface (USB interface) of the network connection module to proceed with charging procedure without having the input interface.

The portable storage module has a memory card slot and/or an internal memory card, and can bi-directionally transmits data with the internal memory card and/or an external memory card to proceed with data read/write procedure. Meanwhile, the USB disk and/or the hand-held electronic devices (for example, mobile phone, iPad) and/or PC and/or laptop computer are(is) connected to the network connection interface (USB interface) of the network connection module through the USB interface and/or signal circuit to proceed WiFi communication, and can bi-directionally transmits data with the internal memory card of the portable storage module and/or the external memory card to proceed data read/write procedure. The USB disk and/or the hand-held electronic devices (for example, mobile phone, iPad) and/or PC and/or laptop computer can also transmit(s) data to the Internet through the RJ-45 interface.

The above and other objectives, features and advantages of the present invention will be apparent from the following description of preferred embodiments of the invention with reference to the accompanying drawings.

### BRIEF DESCRIPTION OF THE DRAWINGS

The above and other objectives, features and other advantage of the present invention will be more clearly understood from the following detailed description taken in conjunction with the accompanying drawings, in which:

FIG. 1 is a block diagram illustrating an electronic device according to the present invention; and

FIG. 2 schematically illustrates a preferred embodiment of the electronic device according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

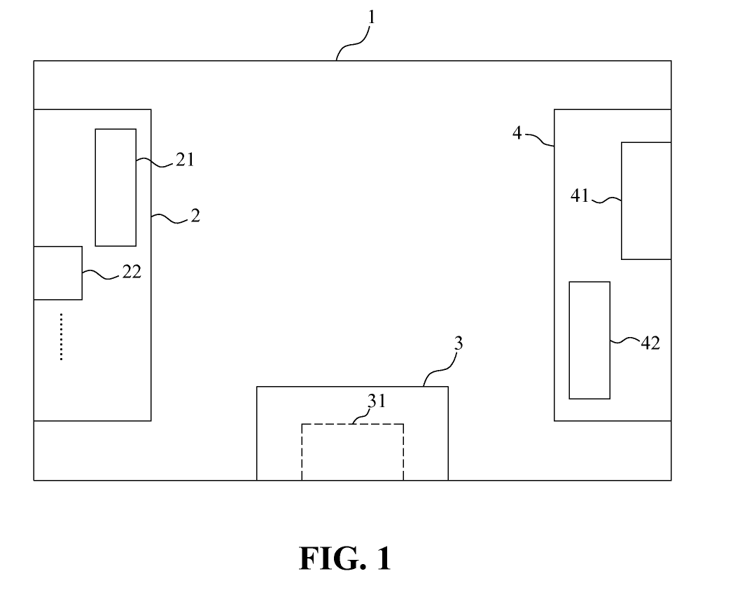

FIG. 1 is a block diagram illustrating an electronic device according to the present invention. As shown in FIG. 1, according to the present invention, the electronic device 1 includes a network connection module 2, a power supply module 3, and a portable storage module 4.

The network connection module 2 comprises signal circuit 21, and network connection interface 22. The signal circuit 21 has WiFi communication function, and the network connection interface 22 is provided for electrically connecting to USB devices or wired network, wherein, for example, the network connection interface 22 is RJ-45 interface, the network connection module 2 is connected to the Internet, the signal circuit 21 converts signals from the network connection interface (RJ-45 interface) 22 into wireless WiFi signals, and transmits/receives the wireless WiFi signals. Besides, the USB disk and/or the hand-held electronic devices (for example, mobile phone, iPad) and/or PC and/or laptop computer transmit(s) data to the Internet through the network connection interface (RJ-45 interface) 22. Meanwhile, for example, the network connection interface 22 is USB interface which accepts an USB disk, and bi-directionally transmits data with the USB disk to proceed data read/write procedure through the network connection interface (USB interface) 22 and/or the signal circuit 21 proceeding WiFi communication.

The power supply module 3 is charged by an external power source which is an AC (Alternating Current) power source with 110 voltage or 240 voltage through an input interface 31 of the power supply module 3. And after the charging procedure, the power supply modules 3 provides electric power to the network connection module 2 and the portable storage module 4 without electrically connecting with the AC power source.

While the AC power source is turn-on and input through the input interface 31, the power supply module 3 converts the input AC power into the DC (Direct Current) power to charge a battery, and at least one LED element is used to indicate remaining electric power of the battery. The power supply module 3 can also charge hand-held electronic devices (for example, mobile phone, iPad) connected with the network connection interface (USB interface) 22 through the network connection interface (USB interface) 22 of the network connection module 2.

Meanwhile, the input interface 31 is optional, and, in other words, the power supply module 3 can use the network connection interface (USB interface) 22 of the network connection module 2 to proceed charging procedure without having the input interface 31.

The portable storage module 4 has a memory card slot 41 and/or an internal memory card 42, and can bi-directionally transmits data with the internal memory card 42 and/or an external memory card to proceed data read/write procedure. Meanwhile, the USB disk and/or the hand-held electronic devices (for example, mobile phone, iPad) and/or PC and/or laptop computer are(is) connected to the network connection interface (USB interface) 22 of the network connection module 2 through the network connection interface (USB interface) 22 and/or signal circuit 21 to proceed WiFi communication, and can bi-directionally transmits data with the internal memory card 42 of the portable storage module 4 and/or the external memory card to proceed data read/write procedure. The USB disk and/or the hand-held electronic devices (for example, mobile phone, iPad) and/or PC and/or laptop computer can also transmit data to the Internet through the RJ-45 interface.

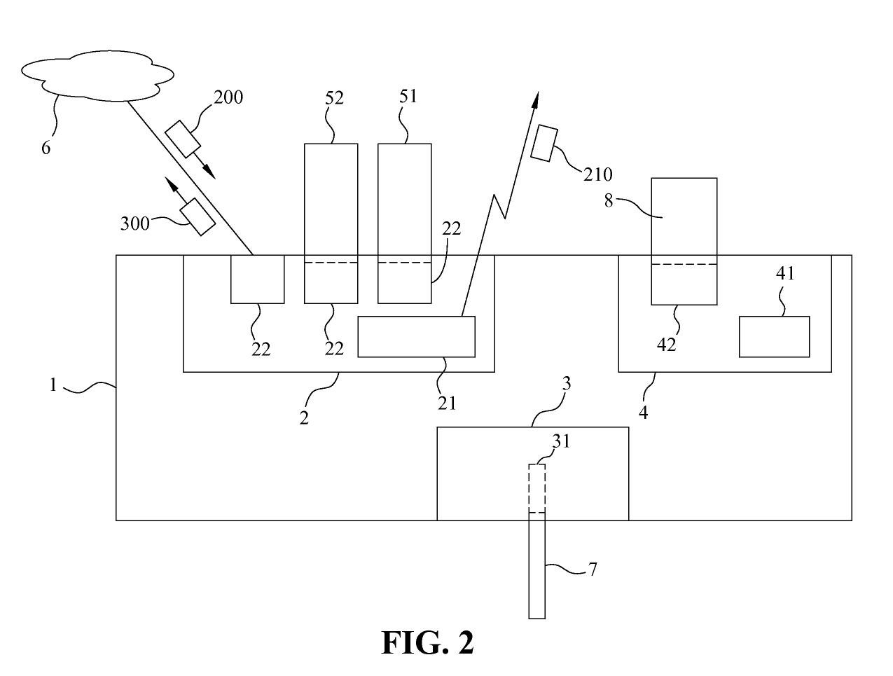

FIG. 2 schematically illustrates a preferred embodiment of the electronic device according to the present invention. As shown in FIG. 2, according to an embodiment of the present invention, the electronic device 1 includes a network connection module 2, a power supply module 3, and a portable storage module 4.

The network connection module 2 comprises signal circuit 21, and at least one network connection interface 22. The signal circuit 21 has WiFi communication function, and the at least one network connection interface 22 is provided for electrically connecting to USB devices or wired network, wherein, for example, a network connection interface 22 is RJ-45 interface, the network connection module 2 is connected to the Internet 6, the signal circuit 21 converts signals 200 from the network connection interface (RJ-45 interface) 22 into wireless WiFi signals 210, and transmits the wireless WiFi signals 210. Besides, the USB disk 51 transmits data 300 to the Internet 6 through the network connection interface (the RJ-45 interface) 22. Meanwhile, for example, another network connection interface 22 is USB interface which accepts USB disk 51, and bi-directionally transmits data with the USB disk 51 to proceed data read/write procedure through the another network connection interface (USB interface) 22 and/or the signal circuit 21 proceeding WiFi communication.

The power supply module 3 is charged by an external power source 7 which is an AC (Alternating Current) power source with 110 voltage or 240 voltage through an input interface 31 of the power supply module 3. And after the charging procedure, without electrically connecting with the AC power source 7, the power supply modules 3 provides electric power to the network connection module 2 and the portable storage module 4.

While the AC power source is turn-on and input through the input interface 31, the power supply module 3 converts the input AC power into the DC (Direct Current) power to charge a battery, and at least one LED element is used to indicate remaining electric power of the battery. The power supply module 3 can also charge hand-held electronic devices 52 (for example, mobile phone, iPad) connected with another network connection interface (USB interface) 22 through another network connection interface (USB interface) 22 of the network connection module 2.

Meanwhile, the input interface 31 is optional, and, in other words, the power supply module 3 can use another network connection interface (USB interface) 22 of the network connection module 2 to proceed with charging procedure without having the input interface 31.

The portable storage module 4 has a memory card slot 41 and/or an internal memory card 42, and can bi-directionally transmits data with the internal memory card 42 and/or an external memory 8 to proceed data read/write procedure. Meanwhile, the USB disk 51 and/or the hand-held electronic devices 52 (for example, mobile phone, iPad) are(is) connected to the another network connection interface (USB interface) 22 of the network connection module 2 through the another network connection interface (USB interface) 22 and/or signal circuit 21 to proceed WiFi communication, and can bi-directionally transmits data with the internal memory card 42 of the portable storage module 4 and/or the external memory card 8 to proceed data read/write procedure. The USB disk 51 and/or the hand-held electronic devices 52 (for example, mobile phone, iPad) can also transmit data 300 to the Internet 6 through the RJ-45 interface.

If the invention has been described hereinafter with reference to specific embodiment, numerous variations and alternative configurations will be apparent to the man skilled in the art. Accordingly it will be apparent to the man skilled in the art that such variations and alternative configurations are also embraced by the present invention and the scope of the invention is restricted only in accordance with the accompanying claims and equivalents thereof.

What is claimed is:

1. An electronic device, comprising:
a network connection module comprises a signal circuit, one network connection interfaces as a RJ-45 interface, and another network connection interfaces as an USB interface, wherein the signal circuit has WiFi communication function, the network connection interface as the RJ-45 interface is provided for electrically connecting to wired network, the network connection module is connected to the Internet, and the signal circuit converts signals from the network connection interface as the RJ-45 interface into wireless WiFi signals, and transmits the wireless WiFi signals;
a power supply module charged by an AC power source through the another network connection interface as an USB interface of the network connection module, and after a charging procedure, without electrically connecting with the AC power source, the power supply modules providing electric power to the network connection module; and
a portable storage module having a memory card slot and/or an internal memory card, bi-directionally transmits data with the internal memory card and/or an external memory to proceed data read/write procedure, and after the charging procedure, without electrically connecting with the AC power source, the power supply modules providing electric power to the portable storage module.

2. The electronic device as claimed in claim 1, wherein an USB disk connected to the another network connection interface as the USB interface of the network connection module bi-directionally transmits data with the internal memory card of the portable storage module and/or the external memory card to proceed data read/write procedure through the another network connection interface as the USB interface.

3. The electronic device as claimed in claim 1, wherein a hand-held electronic device connected to the another network connection interface as the USB interface of the network connection module bi-directionally transmits data with the internal memory card of the portable storage module and/or the external memory card to proceed data read/write procedure through the another network connection interface as the USB interface and/or the signal circuit to proceed WiFi communication.

4. The electronic device as claimed in claim 2, wherein the USB disk transmits data to the Internet through the network connection interface as the RJ-45 interface of the network connection module, and bi-directionally transmits data with the USB disk to proceed data read/write procedure through the another network connection interface as the USB interface and/or the signal circuit to proceed WiFi communication.

5. The electronic device as claimed in claim 3, wherein the hand-held electronic device transmits data to the Internet through the network connection interface as the RJ-45 interface of the network connection module, and bi-directionally transmits data with the internal memory card of the portable storage module and/or the external memory card to proceed data read/write procedure through the another network connection interface as the USB interface and/or the signal circuit to proceed WiFi communication.

6. An electronic device, comprising:
a network connection module comprises a signal circuit, a network connection interfaces as a RJ-45 interface, and another network connection interfaces as an USB interface, wherein the signal circuit has WiFi communication function, the network connection interface as the RJ-45 interface is provided for electrically connecting to wired network, the network connection module is connected to the Internet, and the signal circuit converts signals from the network connection interface as the RJ-45 interface into wireless WiFi signals, and transmits the wireless WiFi signals;
a power supply module having an input interface electrically connecting with an AC power source, the power supply module charged by the AC power source through the input interface, and after a charging procedure, without electrically connecting with the AC power source, the power supply modules providing electric power to the network connection module; and
a portable storage module having a memory card slot and/or an internal memory card, bi-directionally transmits data with the internal memory card and/or an external memory to proceed data read/write procedure, and after the charging procedure, without electrically connecting with the AC power source, the power supply modules providing electric power to the portable storage module.

7. The electronic device as claimed in claim 6, wherein an USB disk connected to the another network connection interface as the USB interface of the network connection module bi-directionally transmits data with the internal memory card of the portable storage module and/or the external memory card to proceed data read/write procedure through the another network connection interface as the USB interface, and while the AC power source is turn-on and input through the input interface, the power supply module converts the input AC power into a DC power to charge a battery, and at least one LED element is used to indicate remaining electric power of the battery.

8. The electronic device as claimed in claim 6, wherein a hand-held electronic device connected to the another network connection interface as the USB interface of the network connection module bi-directionally transmits data with the internal memory card of the portable storage module and/or the external memory card to proceed data read/write procedure through the another network connection interface as the USB interface and/or the signal circuit to proceed WiFi communication, and while the AC power source is turn-on and input through the input interface, the power supply module converts the input AC power into a DC power to charge a battery and at least one LED element is used to indicate remaining electric power of the battery, and the power supply module charges the hand-held electronic devices through the another network connection interface as the USB interface of the network connection module.

9. The electronic device as claimed in claim 7, wherein the USB disk transmits data to the Internet through the network connection interface as the RJ-45 interface of the network connection module, and bi-directionally transmits data with the USB disk to proceed data read/write procedure through the another network connection interface as the USB interface and/or the signal circuit to proceed WiFi communication.

10. The electronic device as claimed in claim 8, wherein the hand-held electronic device transmits data to the Internet through the network connection interface as the RJ-45 interface of the network connection module, and bi-directionally transmits data with the internal memory card of the portable storage module and/or the external memory card to proceed data read/write procedure through the another network connection interface as the USB interface and/or the signal circuit to proceed WiFi communication.
